(19) United States
(12) Patent Application Publication
(10) Pub. No.: US 2002/0176355 A1
(43) Pub. Date: Nov. 28, 2002

(54) Snooping standby router

(76) Inventors: Alan Mimms, Spokane, WA (US); Dennis Lee Weaver, Spokane, WA (US)

Correspondence Address: CHRISTIE, PARKER & HALE, LLP, 350 WEST COLORADO BOULEVARD, SUITE 500, PASADENA, CA, 91105, US

(21) Appl. No.: 10/152,955

(22) Filed: May 21, 2002

Related U.S. Application Data
(60) Provisional application No. 60/292,976, filed on May 22, 2001.

(51) Int. Cl. H04J 1/16; H04J 3/14

(52) U.S. Cl. 370/216; 370/219; 370/220

(57) ABSTRACT

A data communications network having a primary router, a secondary router and a peer router is disclosed. In operation the primary and peer router conduct a peer session to exchange information regarding the current state of the network topology. In addition, the secondary router monitors the peer session to maintain awareness of the current state of the network topology and replaces the primary router upon detecting a failure of the primary router.

### CROSS REFERENCE TO RELATED APPLICATION

This application claims priority of U.S. Provisional Patent application Serial No. 60/292,976, entitled “SNOOPING STANDBY ROUTER”, filed May 22, 2001, the contents of which is incorporated herein by reference as if set forth in full.

### FIELD OF THE INVENTION

The present invention is generally related to redundant routing and more particularly related to a method and apparatus for maintaining synchronization between a primary router and a secondary router.

### BACKGROUND

Data networks commonly route data packets or frames from a source network node to one or more destination network nodes. When a network device such as for example, a router receives a packet or frame, the device examines the packet or frame in order to determine how the packet or frame is to be forwarded. Additional forwarding decisions may be made as necessary by intermediate network devices until the packet or frame is received at a desired destination node.

Data networks commonly employ one of a variety of distributed routing procedures to route data packets through a network from a source node to a destination node. In operation network routers maintain routing tables to carry out the routing function. When a packet arrives at a router, an address contained within the packet (for example the destination address) is used to retrieve an entry from the routing table that indicates the next hop, or next node, along a desired route to the destination node. The router then forwards the packet to the indicated next hop node. The process is repeated at successive router nodes until the packet arrives at the desired destination node.

Routers often exchange routing information with other routers to maintain the routing tables. Routers may conduct “peer” sessions to exchange information with its peers in the network to maintain the active state of network links among neighboring nodes. Peer sessions often rely on the exchange of transport layer information using Transport Control Protocol (TCP) or User Datagram Protocol (UDP). TCP and UDP packets convey state information that each “peer” router must understand in order to conduct the session properly. Conventionally, when one of the peer routers participating in a session fails, it has typically been necessary for the other peer router to terminate the session and start a fresh session with a standby router.

One of the primary concerns of service providers is network downtime. Typically service providers attempt to minimize network outages due to equipment (i.e., hardware) and all too common software failures. Developers of computer systems often use redundancy measures to minimize downtime and enhance system resiliency. Redundant designs rely on alternate or backup resources to overcome hardware and/or software faults. Ideally, the redundancy architecture allows the computer system to continue operating in the face of a fault with minimal service disruption, for example, in a manner transparent to the service provider's customer.

In operation, if a primary device fails a corresponding backup device may be substituted for the primary device. However, if the backup device was not in an active state the primary device failed then the backup device must be booted and configured to operate as a substitute for the failing element. In addition, the backup device may need to determine the current active state of the failed primary device to allow the backup device to take over where the failed primary device left off. The time required to activate the backup device is commonly referred to as the synchronization time. In practice a long synchronization time may significantly disrupt system service, and in the case of a computer network device, if synchronization is not done quickly enough, numerous network connections may be lost which may directly impact the service provider's availability statistics.

### SUMMARY OF THE INVENTION

In one aspect of the present invention a data communication network includes a primary router, a peer router and a secondary router wherein the primary router and peer router conduct a peer session. In accordance with an exemplary embodiment, packets in the peer session that originate from the primary router are received by the secondary router en route to the peer router. Similarly, packets in the peer session that originate from the peer router are received by the secondary router en route to the primary router.

In a further aspect of the present invention a data communication network includes a primary router, a peer router and a secondary router wherein the primary router and peer router conduct a peer session, characterized in that the secondary router monitors the peer session and replaces the primary router upon detecting failure of the primary router.

### BRIEF DESCRIPTION OF THE DRAWINGS

These and other features, aspects, and advantages of the present invention will become better understood with regard to the following description, appended claims, and accompanying drawings, where:

FIG. 1 is a system block diagram of a local area network (LAN) comprising a plurality of hosts and a primary and secondary router for routing communications across a computer network in accordance with an exemplary embodiment of the present invention;

FIG. 2 is a simplified block diagram illustrating a network environment including a packet switching node, such as a router, according to an exemplary embodiment of the present invention;

FIG. 3 is a block diagram of a line card according to an exemplary embodiment of the present invention;

FIG. 4 is a packet switching controller according to an exemplary embodiment of the present invention;

FIG. 5 graphically illustrates the protocol stack processing of outgoing control messages by the secondary router of FIG. 1 in accordance with an exemplary embodiment of the present invention;

FIG. 6 graphically illustrates the protocol stack processing of incoming control messages by the secondary router of FIG. 1 in accordance with an exemplary embodiment of the present invention;

FIG. 7 is a simplified block diagram of a local area network illustrating the routing of control messages between the primary and secondary routers during a peer session in accordance with an exemplary embodiment of the present invention; and

FIG. 8 is a simplified block diagram of an alternate local area network (LAN) wherein incoming protocol messages are forwarded to both a primary and secondary router during a peer session in accordance with an exemplary embodiment of the present invention.

### DESCRIPTION OF THE INVENTION

An exemplary embodiment of the present invention provides a method for reducing loss and latency in the event of failure of an active network device such as a router. In order to appreciate the advantages of the present invention, it will be beneficial to describe the invention in the context of an exemplary network environment.

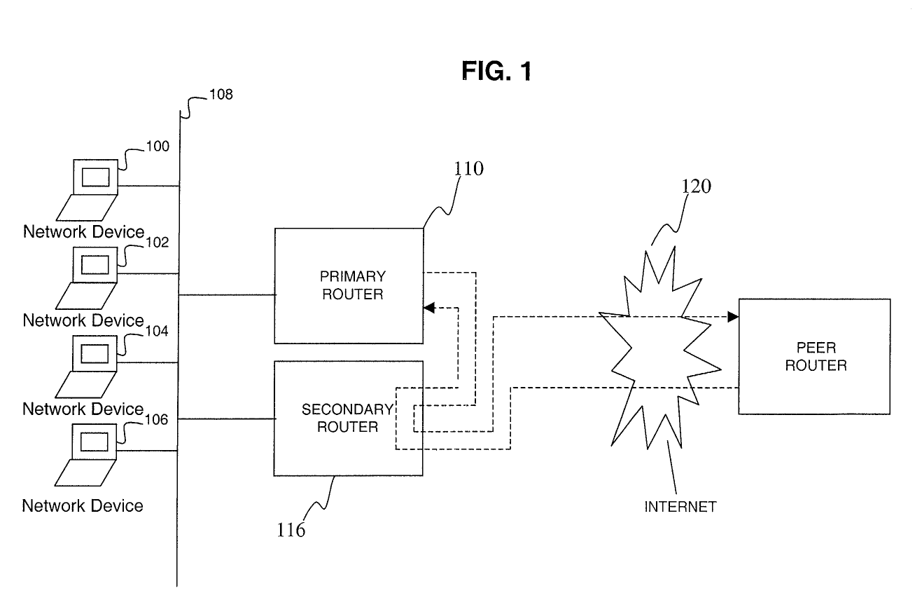

FIG. 1 is a simplified block diagram of a local area network (LAN) comprising a plurality of hosts 100, 102, 104, 106 and a plurality of routers 110 and 116. The routers 110, 116 may be viewed as being coupled to the LAN 108 to provide gateway access to a computer network 120. The computer network 120, may comprise, for example, the Internet or other global or local computer networks. The routers 110 and 116 may also be coupled to one or more other LANs (not shown).

One of skill in the art will appreciate that for this invention, any data processing device in a LAN may be considered a host. For example, the hosts 100, 102, 104, 106 may be a terminal, personal computer, workstation, minicomputer, mainframe, etc. Further, the LANs in this and other embodiments may have one or more different configurations including, but not limited to, Ethernet (IEEE 802.3), token ring (IEEE 802.5) and FDDI (ANSI X3T9.5).

At any one time, one of the routers 110 or 116 assumes the state of primary or active router. In an exemplary network, the hosts 100, 102, 104, 106 are preferably configured to point to the primary router. Thus, when a host needs to send data packets outside of LAN 108, it directs them to the primary router.

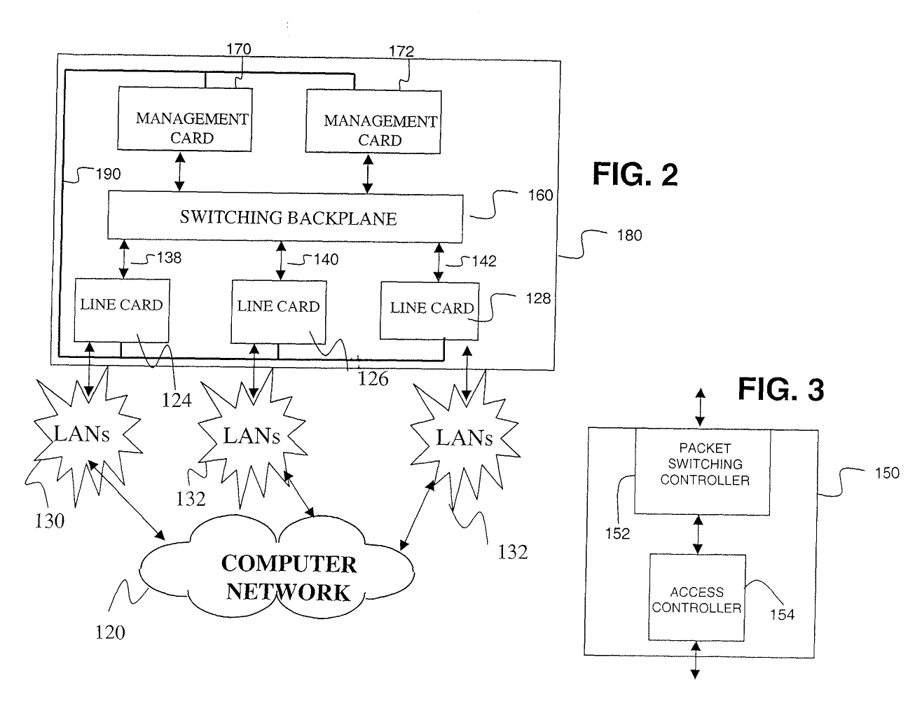

One of skill in the art will appreciate that the present invention may be implemented in a variety of manners. For example, in one embodiment, the primary and secondary routers may be realized in a packet switching node 180. Referring to FIG. 2, an exemplary packet switching node may comprise a plurality of line cards 124, 126 and 128 interconnected by a switching backplane 160. In the described exemplary embodiment, the line cards may be interconnected to respective groups of LANs 130, 132, 134 and preferably interconnected to each other over data paths 138, 140, 142 via the switching backplane 160.

In accordance with an exemplary embodiment the line cards 124, 126 and 128 may forward packets to and from their respective groups of LANs 130, 132, 134 in accordance with one or more operative communication protocols, such as, for example, media access control (MAC) bridging and Internet Protocol (IP) routing. The line cards 124, 126 and 128 may communicate with other packet switching nodes or routers over a computer network 120, which may include for example the Internet and/or other global or local computer networks. In the described exemplary embodiment management cards 170 and 172 may be coupled to the switching backplane to control a variety of functions in support of the operation of the packet switching node 180.

FIG. 3 is a simplified block diagram of an exemplary line card 150, that may be similar to one or more of the line cards 124, 126 and 128 of FIG. 2. The described exemplary line card 150 may include an access controller 154 coupled between the LANs and a packet switching controller 152. The described exemplary access controller 154 may receive inbound packets from LANs and may perform flow-independent physical and MAC layer operations on the inbound packets. The described exemplary access controller 154 may transmit the inbound packets to the packet switching controller 152 for flow-dependent processing. The access controller 154 may also receive outbound packets from the packet switching controller 152. The access controller may perform physical and MAC layer operations on the outbound packets and transmit the outbound packets to the LANs or to a computer network, such as, for example, the computer network 120 of FIG. 2.

The described exemplary packet switching controller 152 may receive inbound packets, classify the packets, generate application data for the inbound packets, modify the inbound packets in accordance with the application data, and transmit the modified inbound packets on a switching backplane, such as, for example, the switching backplane 160 of FIG. 2. In an exemplary embodiment the packet switching controller 152 may also receive outbound packets from other packet switching controllers over the switching backplane, and transmit the outbound packets to the access controller 154 for forwarding to the LANs or to the computer network, such as, for example, the computer network 120 of FIG. 2. In other embodiments, the packet switching controller 152 may also subject one or more outbound packets to egress processing prior to forwarding them to the access controller 154. The packet switching controller 152 may be implemented in non-programmable logic, programmable logic or any combination of programmable and non-programmable logic.

In the described exemplary embodiment the management cards may manage the routing function at the network layer. The described exemplary management cards may comprise a general-purpose processor executing one or more special-purpose routing protocols, or may alternatively be implemented using special-purpose hardware. In an exemplary embodiment the management cards may maintain a routing database or routing table. The routing table reflects the overall topology of the entire network.

Referring back to FIG. 2, in an exemplary embodiment of the present invention the management cards 170 and 172 may communicate in peer sessions with neighboring routers in the network via the switching backplane 160 and the line cards 124, 126 and 128 to exchange topology-related information so that the routing tables are kept current despite changes in the network topology. Thus, for example, when a new node is configured on a network segment, that information is broadcast in a peer session throughout the network to enable each router to update its routing table to reflect the current session state.

In an exemplary embodiment of the present invention a forwarding table may also be stored on the line cards to map the destination address of each received packet to the identity of the route by which the packet should be forwarded. In the described exemplary embodiment, the various forwarding tables on the line cards may contain a subset of the information from the routing table stored by the management cards. In accordance with an exemplary embodiment the management cards may periodically update the individual forwarding tables on the line cards as changes to the routing table occur via a shared memory communication path 190.

In operation, when a data packet arrives at a line card, the packet switching controller 152 (see FIG. 3) may make a next hop determination based upon at least a portion of the destination address. For example, in one embodiment the packet switching controller may utilize an address matching algorithm to search the forwarding table for an entry corresponding to the destination address located in the network layer header of the received data packet. The packet switching controller may then forward the packet to the appropriate line card through the switching backplane 160 at what is referred to as wirespeed or linespeed, which is the maximum speed capability of the particular network. The receiving line card then transmits the packet onto the appropriate network segment. Further, when a control message arrives at a line card during a peer session, the packet switching controller may forward the packet to the corresponding management card through the switching backplane.

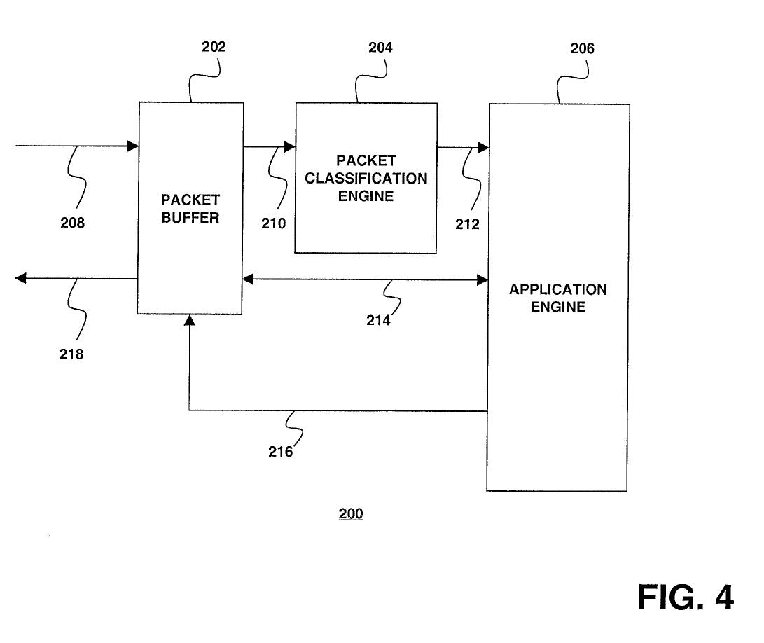

FIG. 4 is a block diagram of a programmable packet switching controller 200 according to an exemplary embodiment of the present invention. The programmable packet switching controller 200, for example, may be similar to the packet switching controller 152 of FIG. 3. In the described exemplary embodiment the programmable packet switching controller 200 may have flow resolution logic for classifying and routing incoming flows of packets. Packet switching controllers in other embodiments may include more or less number of components.

For example, a packet switching controller in another embodiment may include a pattern match module for comparing packet portions against a predetermined pattern to look for a match. The packet switching controller in yet another embodiment may include an edit module for editing inbound packets to generate outbound packets. Further, packet switching controllers in still other embodiments may include other components, such as, for example, a policing engine, in addition to or instead of the components included in the programmable packet switching controller 200.

Due to its programmable nature, the programmable packet switching controller 200 preferably provides flexibility in handling many different protocols and/or field upgradeability/programmability. The programmable packet switching controller 200 may also be referred to as a packet switching controller, a switching controller, a programmable packet processor, a network processor, a communications processor or as another designation commonly used by those skilled in the art.

The described exemplary programmable packet switching controller 200 includes a packet buffer 202, a packet classification engine 204, and an application engine 206. The programmable packet switching controller 200 preferably receives inbound packets 208. The packets (or data units) may include, but are not limited to, Ethernet frames, ATM cells, TCP/IP and/or UDP/IP packets, and may also include other Layer 2 (Data Link/MAC Layer), Layer 3 (Network Layer) or Layer 4 (Transport Layer) data units. For example, the packet buffer 202 may receive inbound packets from one or more Media Access Control (MAC) Layer interfaces over the Ethernet.

In an exemplary embodiment the received packets may be stored in the packet buffer 202. The packet buffer 202 may include a packet FIFO for receiving and temporarily storing the packets. The packet buffer 202 preferably provides the stored packets or portions thereof to the packet classification engine 204 and the application engine 206 for processing.

The packet buffer 202 may also include an edit module for editing the packets prior to forwarding them out of the switching controller as outbound packets 218. The edit module may include an edit program construction engine for creating edit programs real-time and/or an edit engine for modifying the packets. The application engine 206 preferably provides application data 216, which may include a disposition decision for the packet, to the packet buffer 202, and in one embodiment the edit program construction engine preferably uses the application data to create the edit programs. The outbound packets 218 may be transmitted over a switching fabric interface to communication networks, such as, for example, the Ethernet.

The packet buffer 202 may also include either or both a header data extractor and a header data cache. The header data extractor preferably is used to extract one or more fields from the packets, and to store the extracted fields in the header data cache as extracted header data. The extracted header data may include, but are not limited to, some or all of the packet header. In an Ethernet system, for example, the header data cache may also store the first N bytes of each frame.

In an exemplary embodiment the extracted header data is preferably provided in an output signal 210 to the packet classification engine 204 for processing. The application engine may also request and receive the extracted header data over an interface 214. The extracted header data may include, but are not limited to, one or more of Layer 2 MAC addresses, 802.1P/Q tag status, Layer 2 encapsulation type, Layer 3 protocol type, Layer 3 addresses, ToS (type of service) values and Layer 4 port numbers. In other embodiments, the output signal 210 may include the whole inbound packet, instead of or in addition to the extracted header data. In still other embodiments, the packet classification engine 204 may be used to edit the extracted header data to be placed in a format suitable for use by the application engine, and/or to load data into the header data cache.

In an exemplary embodiment the packet classification engine 204 may include a programmable micro-code driven embedded processing engine. The packet classification engine 204 may be coupled to an instruction RAM (IRAM) (not shown). The packet classification engine preferably reads and executes instructions stored in the IRAM. In one embodiment, many of the instructions executed by the packet classification engine are conditional jumps. In this embodiment, the classification logic includes a decision tree with leaves at the end points that preferably indicate different types of packet classifications. Further, in the described exemplary embodiment branches of the decision tree may be selected based on comparisons between the conditions of the instructions and the header fields stored in the header data cache. In other embodiments, the classification logic may not be based on a decision tree.

As described above, management cards 170 and 172 may comprise a processor for performing the routing functions of the device. In an exemplary embodiment the management card processor may comprise a programmable micro-code driven embedded processing engine. The management card may further comprise an instruction RAM (IRAM) (not shown) coupled to the processor. The processor may read and execute instructions stored in the IRAM.

In the described exemplary embodiment one of the management cards, e.g. management card 170 in FIG. 2, may assume the state of primary or active router. In addition, one of the management cards, e.g. management card 172 in FIG. 2, may function as a redundant or secondary management card or router that mirrors or replicates the active state of the primary management card or router 170. The secondary management card (also known as the secondary router) 172 is generally in stand-by mode unless the primary management card (also known as the primary router) 170 fails, at which point a fail-over to the secondary management card or router 172 is initiated to allow the secondary management card or router 172 to be substituted for the primary management card or router 170.

In the illustrative embodiment in FIG. 2 if management card 170 is initially the primary or active router, it performs the various control functions necessary to support packet routing as previously described. For example, the primary router may participate in peer sessions with neighboring network devices to maintain the overall topology of the network. However, in the described exemplary embodiment the primary and secondary routers share state information from each peer session to maintain real time synchronization between the primary and secondary subsystems.

In one embodiment, real-time synchronization may be achieved by executing the same application programs on the primary and secondary routers and passing control messages en route from or to the primary router during a peer session through the secondary or standby router. In this embodiment the secondary router may then process the packets to monitor the peer session to maintain an accurate routing table that reflects the current status of the network topology.

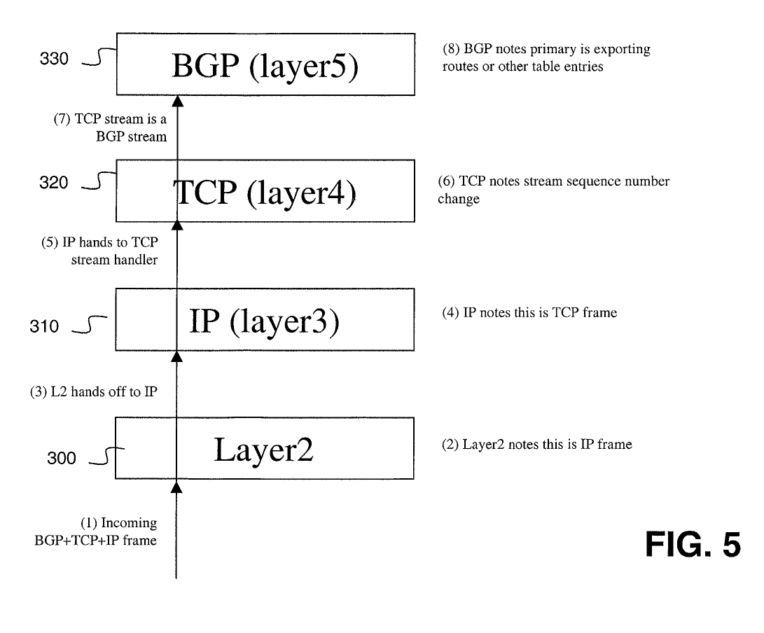

FIG. 5 graphically illustrates the processing of the secondary router protocol stack for an outgoing control or signaling message, i.e. a frame transmitted from the primary router to peer routers during a peer session. For example, when a secondary router operating the border gateway protocol (BGP) receives an outgoing TCP/IP frame it sends the message up through the interface's associated network layer 300. This layer notes that the received frame is an IP frame, strips off the message's physical layer header and trailer, if any, and sends the message up to the IP layer 310. In the described exemplary embodiment the IP layer 310 determines the destination address of the frame and may determine that the frame is a TCP frame and may pass the frame to a TCP stream handler 320. The TCP stream handler identifies the sequence number and that the stream is a BGP stream.

In the described exemplary embodiment a BGP layer 330 may examine the state information in the signaling or control message to determine if updated table entries for example are being communicated by the primary router to the peer routers.

In accordance with an exemplary embodiment, routing table 30 entries added or updated by the peer routers may also be added or updated in the routing tables of the secondary router to maintain a precise awareness of the session state from the peer router(s) viewpoint.

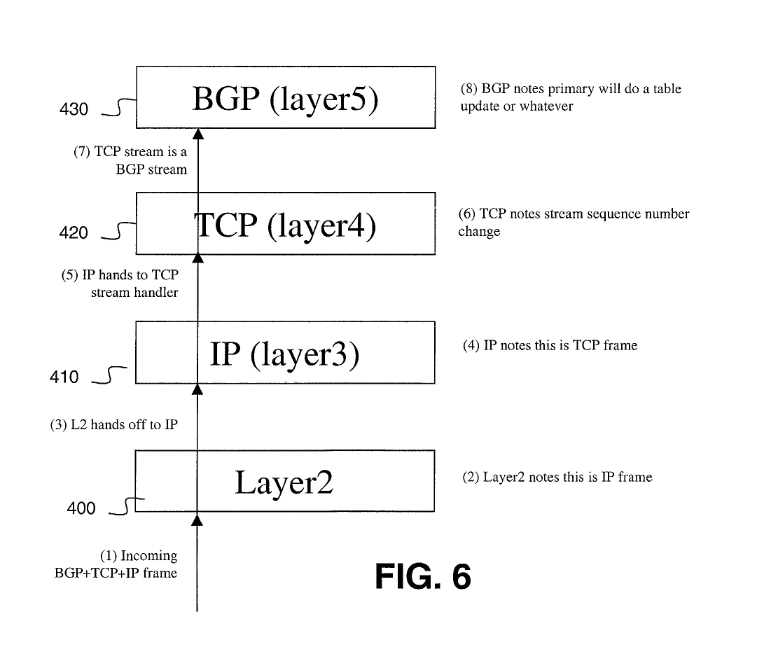

Similarly, FIG. 6 graphically illustrates the processing of the secondary router protocol stack for an incoming frame, i.e. a frame transmitted from a peer router across the computer network to the primary router. In accordance with an exemplary embodiment, the secondary router receives incoming frames from the computer network and routes them to the primary router. For example, when a secondary router operating the border gateway protocol (BGP) receives an outgoing TCP/IP frame it sends the message up through the interface's associated network layer 400. This layer notes that the received frame is an IP frame, strips off the message's physical layer header and trailer, if any, and sends the message up to the IP layer 410.

In the described exemplary embodiment the IP layer determines the destination address of the frame and may determine that the frame is a TCP frame and may pass the frame to a TCP stream handler 420. The TCP stream handler identifies the sequence number and that the stream is a BGP stream. In one embodiment the TCP layer does not generate an acknowledgement to the incoming control message during a peer session when the secondary router is operating in a backup mode.

In the described exemplary embodiment a BGP layer 430 may examine the state information in the signaling or control message to determine if updated table entries for example are being communicated. The secondary router may then update the routing table accordingly to maintain a precise awareness of the session state from the primary router's viewpoint. In this example, BGP and TCP are illustrated, however the present invention may be used in conjunction with a plurality of protocols such as, for example, OSPF and UDP as well as other protocol combinations.

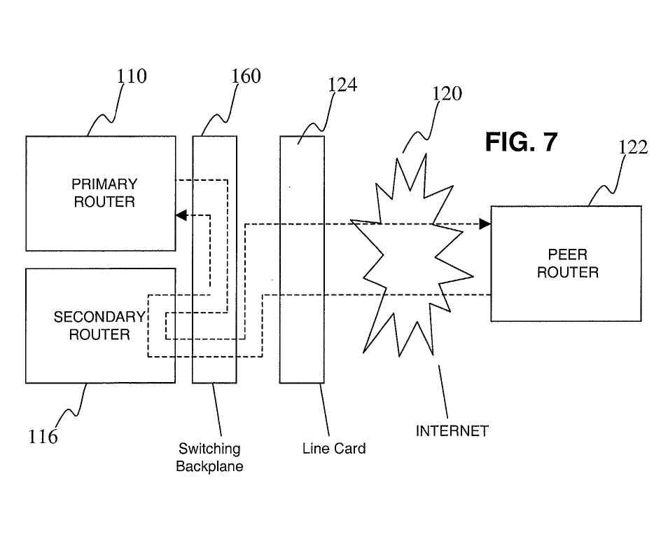

One of skill in the art will appreciate that the present invention may be implemented in variety of ways. For example, referring to FIG. 7, in an exemplary embodiment of the present invention, the primary router 110 may for example forward control messages in accordance with any of a variety of routing protocols to the secondary router 116 via the switching backplane 160. In this embodiment the secondary router may process the outgoing control frame and update it's routing table in response to the processed message to reflect the session state from the peer router's viewpoint. The secondary router may then forward the control frames to the switching backplane for broadcast to the protocol peers 122.

Similarly, in the described exemplary embodiment the line cards associated with the primary and secondary routers may be programmed to forward incoming control or signaling messages received during a peer session to the secondary router via the switching backplane. In the described exemplary embodiment the secondary router may then process the incoming control messages and update it's routing tables in response to the processed message to reflect the current session state from the primary router's viewpoint. In this embodiment the secondary router may forward the control messages to the primary router via the switching backplane.

One of skill in the art will appreciate that passing control messages en route from or to the primary router during a peer session through the secondary router may interrupt control plane communications with the primary router if the secondary router fails. Therefore, in the described exemplary embodiment the primary router may also monitor the status of the secondary router. For example, the primary router may periodically forward a status request to the secondary router. In this embodiment, if the secondary router fails to respond with an acknowledgement the primary router may assume that the secondary router has failed.

Alternatively, the secondary router may automatically forward status messages to the primary router. In this embodiment, if the primary router does not receive a scheduled status message from the secondary router it may again assume that the secondary router has failed. In the described exemplary embodiment if the primary router detects a secondary router failure it may instruct the associated lines cards to forward control messages directly to the primary router. In addition, the primary router may also directly broadcast control messages to the peer routers via the switching backplane and associated line cards, bypassing the failed secondary router.

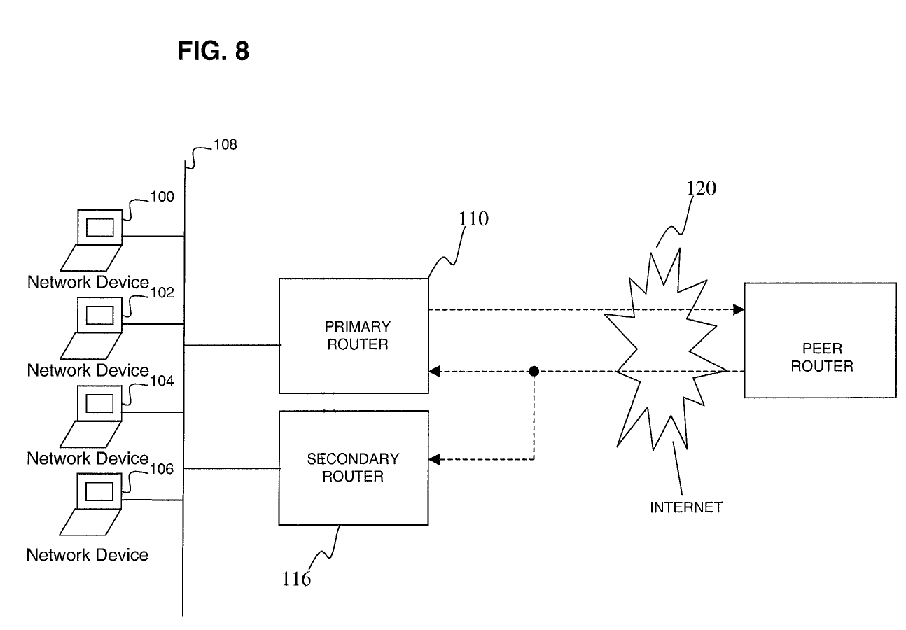

Although an exemplary embodiment of the present invention has been described, it should not be construed to limit the scope of the appended claims. Those skilled in the art will understand that various modifications may be made to the described embodiment and that numerous other configurations are capable of achieving this same result. For example, referring to the simplified block diagram illustrated in FIG. 8, in an exemplary alternate implementation, protocol messages are not indirectly communicated through the secondary router during a peer session. Rather, the line card (not shown) may forward incoming routing protocol messages such as, for example, BGP messages, to both the primary router 110 and the secondary router 116.

In addition, in this embodiment, the secondary router may not process or snoop outgoing messages from the primary router to one or more peer routers on the other side of the network. Therefore, the primary router does not need to monitor the secondary router to avoid peer session interruptions that might be caused by the failure of the secondary router.

In operation, the secondary router typically does not respond to or acknowledge incoming protocol messages during a peer session when functioning in a backup role. Rather the secondary router may again monitor the status of the primary router and upon failure of the primary router may begin responding to routing protocol messages. For example, in one embodiment, the secondary router may intermittently poll the primary router via the shared memory messaging interface 190 (see FIG. 2) and may immediately begin responding to protocol messages when the primary router has been deemed to have failed to respond.

To those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. A data communication network, comprising:
a primary router;
a peer router;
a secondary router; and
a peer session operative between said primary router and said peer router, characterized in that packets in said session originating from said primary router are received by said secondary router en route to said peer router; and packets in said peer session originating from said peer router are received by said secondary router en route to said primary router.

2. The network according to claim 1, further characterized in that said secondary router processes said packets.

3. The network according to claim 1, further characterized in that said secondary router replaces said primary router in said peer session upon detecting a failure of said primary router.

4. The network according to claim 1, further characterized in that said secondary router receives each packet in said peer session.

5. A data communication network, comprising:
a primary router;
a peer router;
a secondary router; and
a peer session operative between said primary router and said peer router, characterized in that said secondary router monitors said peer session and replaces said primary router in said peer session upon detecting failure of said primary router.

6. The network according to claim 5, further characterized in that said secondary router processes control packets transmitted between said primary router and said peer router during said peer session.

7. A data communication network, comprising:
a primary router;
a peer router;
a secondary router; and
a peer session operative between said primary router and said peer router, characterized in that packets in said peer session originating from said peer router are independently received by said secondary router and said primary router.

8. The data communication network of claim 7 wherein said secondary router comprises means for monitoring status of said primary router and replacing said primary router in said peer session upon detecting a failure of said primary router.

9. The data communication network of claim 7 wherein said secondary router further comprises processing means for processing said packets.

10. The data communication network of claim 7 wherein said secondary router comprises storage means for storing protocol routing information reflecting current session state included in said packets.

11. A packet switching node, comprising:
a line card coupled between a network and a switching backplane,
a primary router coupled to said switching backplane; and
a second router coupled to said switching backplane, wherein said line card forwards incoming packets during a peer session between one or more peer routers and said primary router to said primary router and said secondary router.

12. The packet switching node of claim 11 wherein said secondary router comprises means for executing a dynamic routing protocol.

13. The packet switching node of claim 11 wherein said secondary router comprises means for processing said incoming packets to determine current peer session state.

14. The packet switching node of claim 13 wherein said secondary router further comprises storage means for storing current network topology.

15. The packet switching node of claim 11 wherein said secondary router comprises means for monitoring status of said primary router and replacing said primary router in said peer session upon detecting a failure of said primary router.

16. A method for communicating across a network, comprising:
forwarding outgoing control messages originating from a primary router during a peer session to a secondary router en route to a peer router;
processing said outgoing control messages to update a routing table on said secondary router to reflect current session state;
forwarding incoming control messages originating from the peer router during a peer session to a secondary router en route to the primary router; and
processing said incoming control messages to update a routing table on said secondary router to reflect current session state.

17. The method of claim 16 further comprising monitoring status of said primary router and replacing said primary router in said peer session upon detecting a failure of said primary router.
